(19) United States
(12) Patent Application Publication
(10) Pub. No.: US 2013/0007634 A1
(43) Pub. Date: Jan. 3, 2013

(54) SOCIAL ARTIFACT PRIORITIZATION BASED ON A GLOBAL VIEW OF USER COLLABORATION

(75) Inventors: James P. Galvin, JR., Georgetown, KY (US); Andrew L. Schirmer, Andover, MA (US)

(73) Assignee: International Business Machines Corporation, Armonk, NY (US)

(21) Appl. No.: 13/173,152

(22) Filed: Jun. 30, 2011

(51) Int. Cl. G06F 3/00

(52) U.S. Cl. 715/753

(57) ABSTRACT

A method, system, and computer program product for social artifact prioritization in view to a social networking service is provided. The method can include the initial receipt of a characterization of a collaboration between a particular end user and a different end user in a first social networking service. The method additionally can include the selection of information in a second social networking service and the association of the selected information with the different end user. Finally, the method can include the prioritization of a display of the selected information in the second social networking service for the particular end user based upon the association of the selected information with the different end user and the characterization

### BACKGROUND OF THE INVENTION

1. Field of the Invention

The present invention relates to data display and more particularly to data display on social networking services.

2. Description of the Related Art

A social networking service or tool is an online service, platform, or site that focuses on building social networks or social relations among people, e.g. who share interests and/or activities. A social network service essentially consists of a representation of each user (often a profile), his/her social links, and a variety of additional services. Most social network services are web-based and provide means for users to interact over the internet, such as e-mail and instant messaging, which allows users within a local or a global community to connect. In addition, most social networking services also allow users to connect in real time or near real time.

Social networking services manage and distribute information on behalf of the users allowing users to share ideas, activities, events, and interests within their individual networks. The nature of the information managed and distributed varies dramatically from service to service and can include email, attachments, contact lists, transcripts, posts, comments, photographs, and so on.

With all the information available and all the users of social networking services, it can be difficult to ensure the visibility of information most important to a particular user. Different social networking services have developed different approaches for this; for example, some display the most recent posts on the top of a list or populate a list of contacts with the usernames of the most recently contacted people. But most approaches are inwardly focused; each relying on the characteristics of the information each manages and distributes or on how each user shares the information within each tool.

### BRIEF SUMMARY OF THE INVENTION

Embodiments of the present invention address deficiencies of the art in respect to the display of social artifacts in a view to a social networking service and provide a novel and non-obvious method, system, and computer program product for social artifact prioritization in a view to a social networking service. In an embodiment of the invention, a method for social artifact prioritization in a social networking service can include the initial receipt of a characterization of a collaboration between a particular end user and a different end user in a first social networking service. The method additionally can include the selection of information in a second social networking service and the association of the selected information with the different end user. Finally, the method can include the prioritization of a display of the selected information in the second social networking service for the particular end user based upon the association of the selected information with the different end user and the characterization.

In one aspect of the embodiment, the characterization of the collaboration is an identity of an end user participant to the collaboration. In another aspect of the embodiment, the characterization of the collaboration is a relationship between end user participants to the collaboration. In yet another aspect of the embodiment, the characterization of the collaboration is a time of the collaboration. In even yet another aspect of the embodiment, the characterization of the collaboration is a duration of the collaboration. Finally, the characterization of the collaboration canb be a relative importance of the collaboration.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for prioritizing information in a social network service;

FIG. 2 is a schematic illustration of a data processing system configured for prioritizing information in a social network service; and,

FIG. 3 is a flow chart illustrating a process for prioritizing information in a social network service.

### DETAILED DESCRIPTION OF THE INVENTION

Embodiments of the invention provide for social artifact prioritization in a social networking service based upon use of another social network service. In accordance with an embodiment of the invention, an activity report can be exchanged between different social networking services. The activity report can be created based upon the collaboration of users of a first social networking service and can indicate the identity of parties to a collaboration and optionally content included as part of the collaboration. Subsequently, the activity report can be processed by a second, different social networking service and used to prioritize display of related information within the second social networking service. In this way, the collaboration activity of users in one social networking service influences the prioritization of display of information in another social networking service to help ensure the visibility of information most important to a user without requiring aggregation or sharing of information between the social networking services.

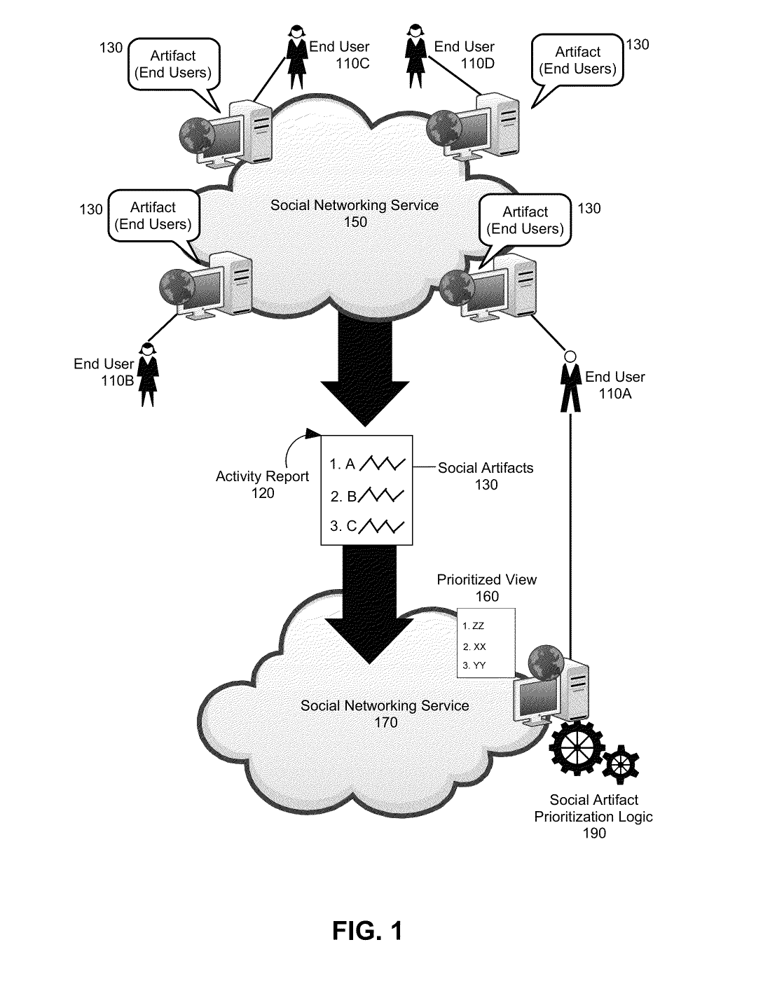

In further illustration, FIG. 1 pictorially shows a process for prioritizing information in a social network service. As shown in FIG. 1, end user 110A from accesses a first social networking service 150 to collaborate with other end users 110B, 110C, 110D. An activity report 120 can then be created by the first social networking service 150 in respect to the collaboration between the end users 110A and end users 110B, 110C, 110D. In particular, the activity report 120 can include references to social artifacts 130 such as social network postings, shared imagery, messaging transcripts, friend lists, shared documents and the like exchanged by the different end users 110A, 110B, 110C, 110D within the first social networking service 150.

Of note, the activity report 120 does not require a specific format or data set, but can allow any collaborative activity in the social networking service 150 to be recorded. In this regard, the activity report 120 additionally can capture the characteristics of the collaborative activity between the end users 110A, 110B, 110C, 110D in the first social networking service 150. For example, the collaborative activity characteristics can include a collaboration frequency, a collaboration recency, a collaboration session length, a collaboration session degree of importance, a collaborator relationship, the identity of the social networking service (for example a name of a tool to access the social networking service 150), the identity of the end users 110A, 110B, 110C, 110D the time of the collaboration, and the artifacts 130 shared or discussed during the collaboration.

Upon the creation of the activity report 120, the activity report 120 can be transmitted electronically to a second, different social networking service 170. Upon receipt of the activity report 120 in the second social networking service 170, social artifact prioritization logic 190 can process the activity report 120 to prioritize a display of information in a view 160 to the social networking service 170. For example, in an aspect of the embodiment, an entry in the activity report 120 indicating a collaboration between end users 110A, 110B can elevate a priority of display for end user 110A of content in social networking service 170 pertaining to end user 110B such that those artifacts 130 associated with end user 110B can be displayed more prominently or at top order of a list in the view 160 for end user 110A relative to those artifacts 130 of other end users 110C, 110D.

Generalized then, the priority for display of content associated with different end users 110B, 110C, 110D in social networking service 170 can be influenced according to characteristics or properties of the collaboration between the end user 110A and the different end users 110B, 110C, 110D in social networking service 150 represented within the activity report 120, including but not limited to a collaboration frequency, collaboration recency, collaboration session length, collaboration session degree of importance, collaborator relationship, the collaboration tool used, the participants in the collaboration, the time of the collaboration, the artifacts shared or discussed during the collaboration, and collaborations with people who also collaborate with other collaborators of the end user. In yet another aspect of the embodiment, the use of multiple different social networking services as opposed to a single other social networking service to collaborate with respect to the same social artifacts 130 can elevate the priority of those social artifacts 130. Finally, a combination of different approaches can also be implemented.

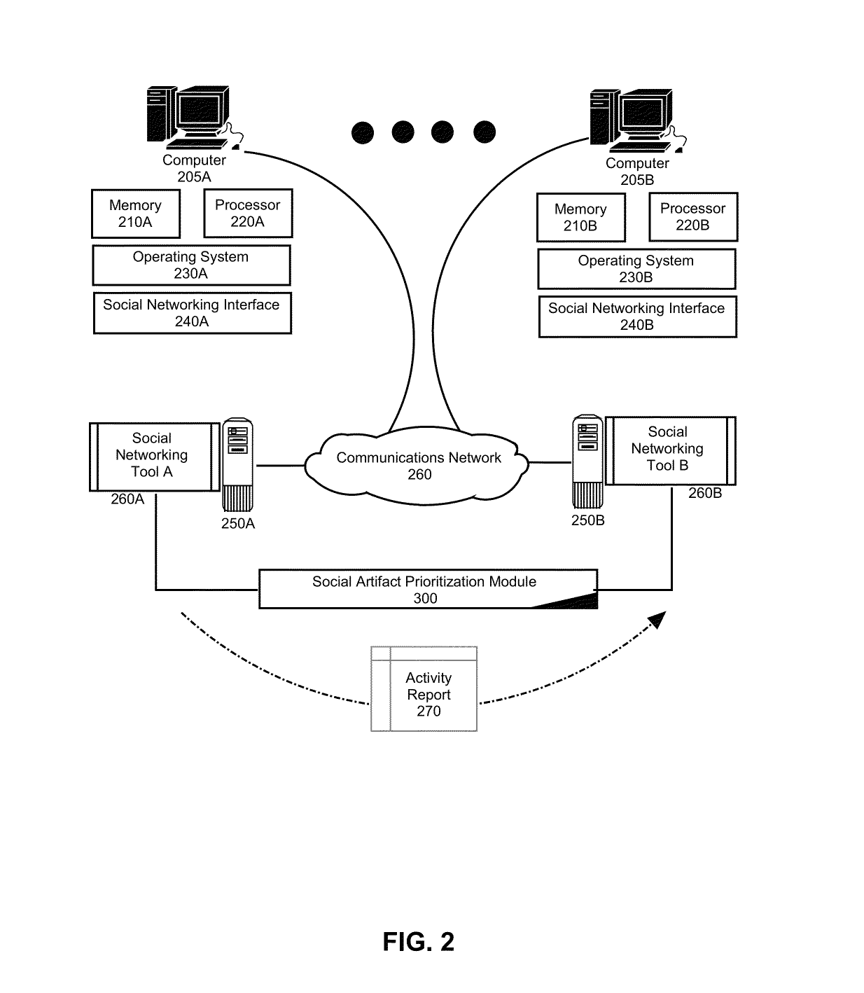

The process described in connection with FIG. 1 can be implemented in a social networking data processing system. In further illustration, FIG. 2 schematically shows a social networking data processing system configured for prioritizing information in a view to a social networking service. The system can include host servers 250A, 250B communicatively coupled to one another over computer communications network 260. Each of the host servers 250A, 250B can include at least one processor and memory and can host the operation of a social networking tool 280A, 280B managing respectively different social networking services.

Computers 205A, 205B additionally can be coupled to the host servers 250A, 250B over the computer communications network 260. Computers 205A, 205B can include a processor 220A, 220B and memory 210A, 210B supporting the execution of an operating system (O/S) 230A, 230B. The O/S 230A, 230B in turn can support the execution of an interface 240A, 240B to social networking services 280A, 280B and can include, by way of example, a content browser enabled to render pages of a Web site through which interactions can be directed in corresponding one of the social networking tools 280A, 280B

Of note, a social artifact prioritization module 300 can be coupled to the social networking tools 280A, 280B either individually, or collectively in that the module 300 can individually execute in each of the host servers 250A, 250B, or separately in one or more other computers accessed by the host servers 250A, 250B. The social artifact prioritization module 300 can include program code which, when executed by at least one processor of a computer can generate an activity report 270 for collaborations between end users in social networking tool 280A to capture the characteristics of the collaborative activity amongst the end users in a social networking service managed by social networking tool 280A. The program code of the module 300 additionally can be enabled upon receiving an activity report 270 for collaborations between end users in social networking tool 280A to identify information provided in a social networking service managed through social networking tool 280B referenced in the activity report 270 and to prioritize a display of the information in a view of the social networking tool 280B related to entries in the activity report 270.

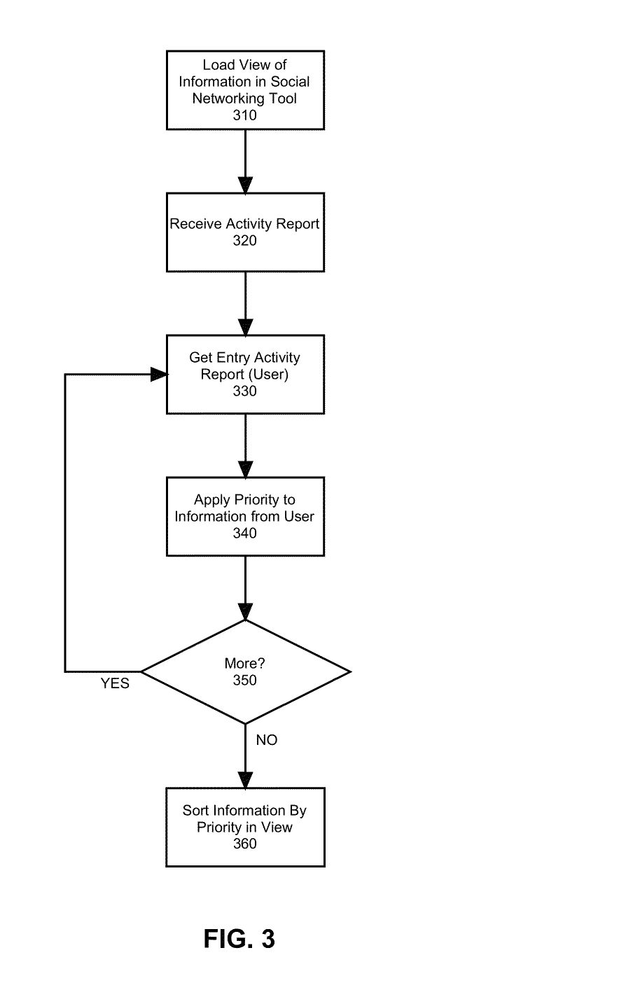

In even yet further illustration of the operation of the program code of the social artifact prioritization module 300, FIG. 3 is a flow chart illustrating a process for prioritizing information in a social network service. Beginning in step 310, a view of information can be loaded for rendering in a view to a social networking service provided by a social networking tool on behalf of an end user. The view can include different information associated with other end users collaborating in the social networking service. In block 320, an activity report can be received referencing different social artifacts for collaborations in a different social networking service between the end user and the other end users and characteristics thereof. In block 330, an entry in the activity report can be retrieved for analysis and in block 340, different priorities for different information in the view pertaining to the entry of the activity report can be established. For example, a higher priority can be established for information in the view associated with a particular one of the other end users referenced in the activity report as having interacted with the end user. In decision block 350, if additional entries in the activity report remain to be processed, a next entry in the activity report can be retrieved in block 330 and the process can repeat in blocks 340 and 350. In decision block 350, if no additional entries remain to be processed in the activity report, in block 360, the view can be rendered with the information in the view sorted according to priority.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for social artifact prioritization in a social networking service comprising:
receiving a characterization of a collaboration between a particular end user and a different end user in a first social networking service;
selecting information in a second social networking service;
associating the selected information with the different end user; and,
prioritizing a display in memory of a computer of the selected information in the second social networking service for the particular end user based upon the association of the selected information with the different end user and the characterization.

2. The method of claim 1, wherein the characterization of the collaboration between the particular end user and the different end user is an entry in an activity report characterizing different collaborations between the particular end user and many different end users in the first social networking service.

3. The method of claim 1, wherein the characterization of the collaboration is an identity of an end user participant to the collaboration.

4. The method of claim 1, wherein the characterization of the collaboration is a relationship between end user participants to the collaboration.

5. The method of claim 1, wherein the characterization of the collaboration is a time of the collaboration.

6. The method of claim 1, wherein the characterization of the collaboration is a duration of the collaboration.

7. The method of claim 1, wherein the characterization of the collaboration is a relative importance of the collaboration.

8. A social artifact prioritization system comprising:
a host server with at least one processor and memory;
a social networking tool executing on the host server and managing a first social networking service; and,
a social artifact prioritization module coupled to the social networking tool, the module comprising program code enabled to receive a characterization of a collaboration between a particular end user and a different end user in a second social networking service, to select information in the first social networking service, to associate the selected information with the different end user, and to prioritize a display of the selected information in the second social networking service for the particular end user based upon the association of the selected information with the different end user and the characterization.

9. The system of claim 8, wherein the characterization of the collaboration is an identity of an end user participant to the collaboration.

10. The system of claim 8, wherein the characterization of the collaboration is a relationship between end user participants to the collaboration.

11. The system of claim 8, wherein the characterization of the collaboration is a time of the collaboration.

12. The system of claim 8, wherein the characterization of the collaboration is a duration of the collaboration.

13. The system of claim 8, wherein the characterization of the collaboration is a relative importance of the collaboration.

14. A computer program product for social artifact prioritization, the computer program product comprising:
a computer readable storage medium having computer readable program code embodied therewith, the computer readable program code comprising:
computer readable program code for receiving a characterization of a collaboration between a particular end user and a different end user in a first social networking service;
computer readable program code for selecting information in a second social networking service;
computer readable program code for associating the selected information with the different end user; and,
computer readable program code for prioritizing a display in memory of a computer of the selected information in the second social networking service for the particular end user based upon the association of the selected information with the different end user and the characterization.

15. The computer program product of claim 14, wherein the characterization of the collaboration between the particular end user and the different end user is an entry in an activity report characterizing different collaborations between the particular end user and many different end users in the first social networking service.

16. The computer program product of claim 14, wherein the characterization of the collaboration is an identity of an end user participant to the collaboration.

17. The computer program product of claim 14, wherein the characterization of the collaboration is a relationship between end user participants to the collaboration.

18. The computer program product of claim 14, wherein the characterization of the collaboration is a time of the collaboration.

19. The computer program product of claim 14, wherein the characterization of the collaboration is a duration of the collaboration.

20. The computer program product of claim 14, wherein the characterization of the collaboration is a relative importance of the collaboration.
